(19) United States
(12) Patent Application Publication
(10) Pub. No.: US 2010/0253168 A1
(43) Pub. Date: Oct. 7, 2010

(54) ELECTRIC DRIVE, PARTICULARLY FOR A FUEL METERING UNIT FOR AN AIRPLANE ENGINE

(75) Inventor: Hubert Herrmann, Haimhausen (DE)

Correspondence Address: CROWELL & MORING LLP;INTELLECTUAL PROPERTY GROUP, P.O. BOX 14300, WASHINGTON, DC, 20044-4300, US

(73) Assignee: MTU Aero Engines GmbH, Munich (DE)

(21) Appl. No.: 12/682,236

(22) PCT Filed: Oct. 4, 2008
(86) PCT No.: PCT/DE2008/001635

§ 371 Date: Apr. 8, 2010

(30) Foreign Application Priority Data
Oct. 10, 2007 (DE) 10 2007 048 642.3

(51) Int. Cl. H02K 16/00

(52) U.S. Cl. 310/114

(57) ABSTRACT

An electric drive, particularly for a fuel metering unit for delivering and metering fuel from a fuel tank into a combustion chamber of an airplane engine, is disclosed. The electric drive drives at least one work module and is composed of at least two engine modules that are supplied separately with electricity and disposed on a common rotor shaft to form a redundant engine arrangement.

This application claims the priority of International Application No. PCT/DE2008/001635, filed Oct. 4, 2008, and German Patent Document No. 10 2007 048 642.3, filed Oct. 10, 2007, the disclosures of which are expressly incorporated by reference herein.

### BACKGROUND AND SUMMARY OF THE INVENTION

The present invention relates to an electric drive, in particular for a fuel metering unit for delivery and metering fuel from a fuel tank into a combustion chamber of an airplane engine, wherein the electric drive drives at least one pump module.

A fuel metering unit for an airplane engine is known from Unexamined German Application DE 199 08 531 A1, which has an electric drive in order to drive a pump module. The drive is embodied as a rotary current motor, wherein a control unit is provided, which is used to supply power and trigger the rotary current motor. In particular, rotary current motors can be designed very cost-effectively and be configured either as a synchronous motor or as an asynchronous motor. Furthermore, reluctance motors may be provided, which even though they feature a very simple structure for the rotor, are characterized by a lower degree of efficiency. Furthermore, fuel metering units are known that have drives, which are designed with rotary current motors, but the disadvantage of these is that commutators of the rotary current motors require a lot of maintenance.

Various drive concepts have their respective advantages and disadvantages, wherein a high level of operational reliability frequently determines the selection of the corresponding engine concept. Precisely the fuel supply to the engines must be guaranteed for the operation of an aircraft, because if the delivery and metering of the fuel into the combustion chamber of airplane engine fails, the engine will also fail.

A standard concept is the drive of the fuel metering unit being operated via the gear box, which is operated via the output of the compressor shaft of airplane engine. However, the problem in this case is that the rotational motion via the output shaft of the airplane engine depends upon the operating point of the engine so that constant rotational speeds cannot be made available.

In order follow the general trend in the building of aircraft to realize the increasing electrification of individual assemblies for operating an aircraft (MEE=more electric engine), fuel metering units are required which are equipped exclusively with electric drives to operate the pump module. The consequence is that precisely with regard to the high required level of operational reliability (1E-6 safety requirement) a special safety requirement is assigned to the drive for the fuel metering unit.

Customary rotary current motors have winding bodies, in which winding short circuits may develop for a wide variety of reasons, which cause the drive to fail. In most cases, rotary current motors have three-phase windings, wherein regardless of the type of rotor winding used in the design of the rotary current motor, in the event of a short circuit, the drive fails. In the case of a drive for a fuel metering unit that is operated solely electrically, a failure due to a winding short circuit would signify the failure of the airplane engine, which may have grave consequences particularly in situations when the aircraft is taking off.

Consequently, the need arises for a fuel metering unit for example, which, in spite of an electric drive for operating the work module(s) designed as pump modules, features a high level of operational reliability, without having to fall back on completely redundantly designed systems, i.e., the overall presence of multiple systems.

As a result, the object of the present invention is producing an electric drive for work modules of an aircraft, which avoids the problems of the above-mentioned prior art and features in particular a simple structure with a high level of operational reliability.

The invention includes the technical teaching that the electric drive is composed of at least two engine modules that are supplied separately with electricity, and are disposed on a common rotor shaft to form a redundant engine arrangement.

The advantage of the inventive embodiment of the electric drive is that a compact motor unit is made available, which is designed individually but nevertheless features a high level of operational reliability. It is not necessary to provide two or more electric drives, which in most cases drive one or more work modules or pump modules via several output shafts. According to the invention, an electric drive is provided which is composed of several engine modules that are supplied separately with electricity, but act on a common rotor shaft.

The supply of the individual engine modules in this case includes providing the electrical power, the triggering of the engine modules with regard to the rotational speed or the minimum or maximum required torque, wherein the engine modules can also be individually disconnected from one another.

Each of the engine modules is disposed on a common rotor shaft, which, for the sake of simplified assembly and replacing individual defective engine modules, may also be designed in a divided or stepped manner. Furthermore, it may be provided that if one engine module has a winding short circuit, the control unit, which is provided to trigger the engine modules, electrically disconnects individual engine modules. In the process, the control unit may include power electronics, which detect the winding short circuit in the engine module and, in the event of the short circuit, shuts down the engine module.

The engine modules in this case are dimensioned such that they each individually have a rated power, which is sufficient for driving the pump module. In particular, subsequent damage may be avoided in this manner, since when a short-circuited motor winding is shut down, it is not possible for fire or the like to develop. The control unit in this case can be designed so that it permits a minimum or maximum power consumption of the motor winding, within which the engine modules may be operated. If the parameters of supply for the individual engine modules leave the specified minimum or maximum values then the engine module may be shut down automatically. In doing so, two or more engine modules may be provided on a common rotor shaft to form the electric drive, wherein the level of operational reliability is further increased with an increasing number of engine modules.

The engine modules advantageously have three-phase rotary current motors each with a stator with at least one winding body and a rotor firmly attached to the rotor shaft, wherein the stators and rotors are arranged in a stacked form and adjacent to one another on the rotor shaft. As a result, a compact unit of an electric drive is produced, which features dimensions that do not have to be larger than customary rotary current motors.

Additional embodiments of the engine modules are related to an asynchronous machine functioning like a type of axial flow machine or a reluctance motor with rotors that are slotted in a star shape. The different motor concepts may also be respectively combined modularly to form the electric drive. Asynchronous motors that are embodied like a type of axial flow machine may feature stators in the form of a disk armature, on which the winding bodies are laterally attached. As a result, the winding bodies point in the direction of the rotors, wherein the disk rotors are arranged plane-parallel thereto. They may be paired as laminated, toroidal disk rotors with likewise laminated, toroidal stators. Consequently, the stators are dimensioned so that the individual engine modules have sufficient required power to operate the pump module, wherein the stators and rotors are dimensioned through the number of laminar elements in order to provide the required power when the engine modules are in operation. The stators formed by the stator cores are then equipped with the winding bodies.

The winding bodies are arranged on the front side on the stators, and point respectively in the direction of the adjacent rotors. Formed between the stators and rotors is a respectively equal air gap, which is dimensioned as small as possible in order to achieve a higher degree of efficiency.

According to a preferred embodiment, the stacked formation of the engine modules features both stators, which are arranged in the center between the stacked engine modules and in the extension direction of the rotor shaft abutting both sides of a rotor, wherein furthermore stators are provided, which are arranged on the end side, and form the end of the electric drive. These rotors arranged on the end each have only one winding body on the front side, whereas the stators arranged in the center feature two opposing winding bodies arranged on its ends on the front side.

Consequently, a stator which is arranged in the center and features a winding body both on the one end on the front side as well as also on the other end on the front side cooperates with two rotors. A stator arranged on the end side features only one winding body, which points in the direction of the adjacent rotor.

The rotors that are arranged in the center may preferably also act in a double-sided manner so that both the winding body which is attached to the first adjacent side as well as the winding body that is attached to the second adjacent side cooperate with the single center rotor. As a result, the electric drive features double the number of winding bodies with respect to the number of rotors.

The rotors are preferably arranged between the stators at an equal distance from the stators so that the rotors run centrically between the stators. A preferred embodiment of the stators may be that the stators may be dividable, and for example be made up of two halves. If a winding body fails, the stator as well as the associated winding body may be replaced without having to completely dismantle the electric drive.

Additional measures improving the invention are explained in greater detail in the following on the basis of the figures along with a description of a preferred exemplary embodiment of the invention.

### BRIEF DESCRIPTION OF THE DRAWINGS

FIG. 1 is a schematic view of a fuel metering unit for the metering and delivery of fuel into the combustion chamber of an airplane engine with an electric drive according to the present invention;

FIG. 2 is a schematic view of an electric drive according to the present invention, which is formed of four engine modules; and

FIG. 3 is a schematic view of the electric drive, which includes at least one engine module and is depicted in an exploded view.

### DETAILED DESCRIPTION OF THE DRAWINGS

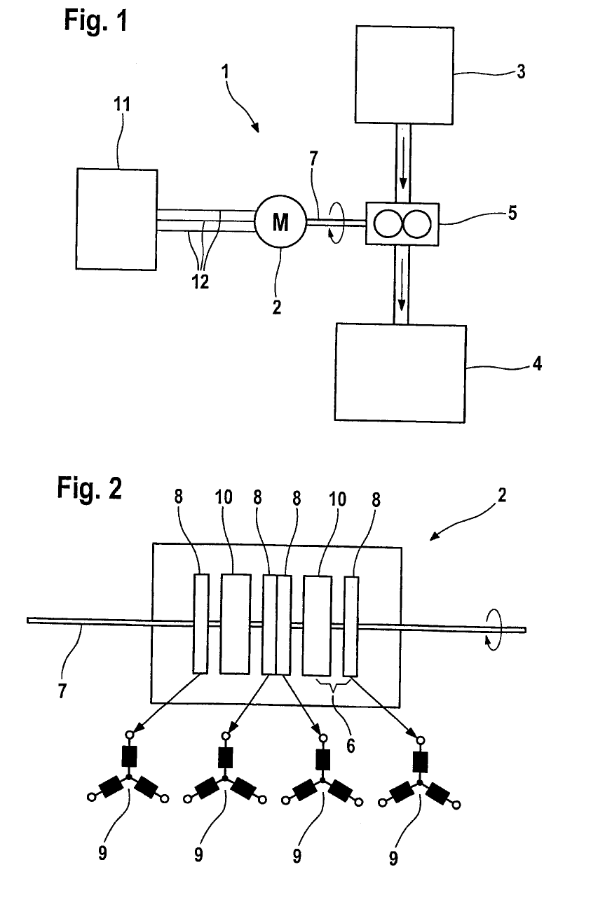

FIG. 1 shows a schematic view of a fuel metering unit 1, which features an electric drive 2 for delivery and metering fuel from a fuel tank 3 into a combustion chamber of an airplane engine 4. The electric drive 2 is shown as a motor symbol with “M,” which is both supplied with electricity as well as triggered by a control unit 11. Depicted between the control unit 11 and the electric drive 2 are supply and control lines 12, a plurality of which are present because of the redundant triggering of the electric drive 2.

The electric drive 2 drives a pump module 5, which is arranged between the fuel tank 3 and the airplane engine 4, via a rotor shaft 7. A single pump module 5 is depicted, wherein the electric drive 2 may also drive several pump modules 5, i.e., all pump modules present between the fuel tank 3 and the airplane engine 4. The flow direction of the fuel is indicated by arrows in the line connections between the fuel tank 3, the pump module 5 and the airplane engine 4.

FIG. 2 depicts a schematic view of the electric drive 2, which has four engine modules 6. These each include a winding body 9, which is applied to the associated stators 8, and is depicted symbolically in the schematic view as a rotary current winding in a star arrangement. The winding bodies 9 are arranged on the stators 8 on the front side and point in the direction of the respective rotors 10.

The rotors 10 are connected in a rotationally fixed manner to the rotor shaft 7, and consequently drive the shaft. The schematic view shows four or three stators 8, wherein there are two stators on the end side and one stator 8 acting in a double-sided manner in the center in the stacked drive 2. The center stator 8 is located between the respective rotors 10 so that there is both a first winding body 9 as well as a second winding body 9 on the center stator 8. The winding bodies consequently each point to the first rotor 10 as well as to the second rotor 10.

Now if one winding body 9 fails, for example due to an electrical short circuit, it can be shut down by the control unit so that the rotor shaft 7 is driven by the remaining three winding bodies 9, which are energized in an unchanged or adjusted manner. The individual stators 8 with the associated winding bodies 9 as well as the rotors 10 form a respective engine module 6. According to the exemplary embodiment, consequently two outside and two inside engine modules 6 are provided.

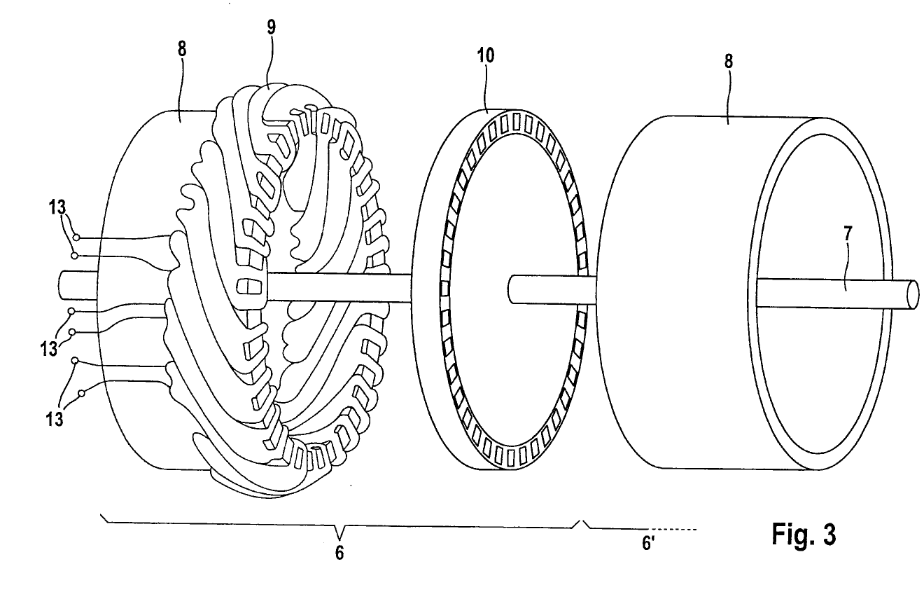

FIG. 3 shows a perspective view of an engine module 6, on which a further engine module 6′ abuts. The engine module 6 depicted in detailed features a stator 8 with a winding body 9, from which winding terminations 13 extend. There are three pairs of these so that, according to the present exemplary embodiment, the winding body 9 is designed as a three-phase winding. Arranged adjacent to the stator 8 is the rotor 10, which is designed as a disk rotor and features a laminated, toroidal form. Following the rotor 10 along the extension direction of the rotor shaft 7 is another stator 8, which is depicted without winding bodies for the sake of simplicity. All rotors 10 and stators 8 extend concentrically around the rotor shaft 7, wherein the rotor 10 is connected in a rotationally fixed manner to the rotor shaft 7. The stator 8 is integrated into a housing, which at the same time forms the housing for the drive and is not depicted further.

The invention is not restricted in terms of its design to the preferred exemplary embodiment described in the foregoing. In fact, a number of variations are conceivable which make use of the described attainment even with basically different designs.

Along these lines, according to the present invention it can be provided that the electrical triggering of the individual modules in the redundant operation be adapted to the required output power. If all modules are in operation then the individual modules are triggered with an electric power, the sum of which corresponds to the required pumping capacity. If one module fails, the power of the remaining modules is adjusted by providing correspondingly greater electrical power so that the there is no drop-off of power to the rotor shaft 7. This triggering can be made possible by the control unit 11, wherein use can be made of appropriate power electronics. Due to this mode of operation an electric drive 2 can be made available that supplies a very high level of operational reliability in spite of a simple and compact structure as well as the realization of a rotary current motor concept based on the redundant winding arrangement.

1.-10. (canceled)

11. An electric drive, comprising:
at least two engine modules that are supplied separately with electricity and disposed on a common rotor shaft to form a redundant engine arrangement.

12. The electric drive according to claim 11, wherein the electric drive is coupled to a work module and wherein the work module delivers fuel from a fuel tank into a combustion chamber of an airplane engine.

13. The electric drive according to claim 11:
wherein the at least two engine modules have three-phase rotary current motors each with a stator with at least one winding body and a rotor firmly attached to the rotor shaft;
and wherein the stators and rotors are arranged in a stacked form and adjacent to one another on the rotor shaft.

14. The electric drive according to claim 11, wherein the at least two engine modules are each designed as an asynchronous machine functioning like a type of axial flow machine or as a reluctance motor with rotors that are slotted in a star shape.

15. The electric drive according to claim 13, wherein the stators have several toroidal stator cores arranged in a row to form a disk motor, to which the winding body is applied.

16. The electric drive according to claim 13, wherein the winding bodies are arranged on a front side on the stators and point in a direction of the rotors.

17. The electric drive according to claim 13, wherein in the stacked form, stators are arranged in a center and in an extension direction of the rotor shaft abutting both sides of a rotor, and stators are arranged on an end side and abut only one rotor and form a respective body end of the electric drive.

18. The electric drive according to claim 17, wherein the stators arranged in the center have two opposing winding bodies arranged on a front side, and wherein the stators arranged on the end side have only one winding body on the front side.

19. The electric drive according to claim 13, wherein the rotors are arranged between the stators at an equal distance from the stators and a respectively equal air gap is formed between the stators and the rotors.

20. The electric drive according to claim 11, wherein the at least two engine modules have a rated power which is respectively sufficient to drive the work module in an event of a failure of one of the at least two engines modules.

21. The electric drive according to claim 11, further comprising a control unit coupled to the at least two engine modules, wherein the control unit triggers the at least two engine modules and, in an event of a winding short circuit of a winding body, shuts down the short-circuited winding body.
